(19) United States
(12) Patent Application Publication
(10) Pub. No.: US 2022/0217241 A1
(43) Pub. Date: Jul. 7, 2022

(54) MANAGEMENT SYSTEM AND MANAGEMENT APPARATUS CONFIGURED TO UPDATE PREVIOUSLY STORED LOCATION INFORMATION, USING LOCATION INFORMATION TRANSMITTED FROM IMAGE FORMING APPARATUS TO WHICH LOCATION INFORMATION WAS REQUESTED, AND IMAGE FORMING APPARATUS

(71) Applicant: KYOCERA Document Solutions Inc., Osaka (JP)

(72) Inventors: Raymond NAVARRO, Osaka (JP); Jaclyn Tiffanie TAN, Osaka (JP); Kyle PERALES, Osaka (JP)

(73) Assignee: KYOCERA Document Solutions Inc., Osaka (JP)

(21) Appl. No.: 17/570,324

(22) Filed: Jan. 6, 2022

(30) Foreign Application Priority Data
Jan. 7, 2021 (JP) 2021-001559

(51) Int. Cl. H04N 1/00

(52) U.S. Cl. CPC H04N 1/00344; H04N 1/00488; H04N 1/00973; H04N 1/00413

(57) ABSTRACT

A management system includes a plurality of image forming apparatuses and a management apparatus. In the management apparatus, a first controller requests, when a first operation device receives a first instruction for designating an image forming apparatus, the designated image forming apparatus to transmit location information, and updates, upon receipt of the location information transmitted in response to the request, the location information stored in a storage device, using the received location information. In the image forming apparatus, a second controller causes a first display device to display a screen urging a user to input an installation location of the image forming apparatus, and causes an alert device to output a notice, when a second communication device receives the request, and transmits, when a second operation device receives the input of the installation location, the location information indicating the installation location that has been received, to the management apparatus.

### INCORPORATION BY REFERENCE

This application claims priority to Japanese Patent Application No. 2021-001559 filed on Jan. 7, 2021, the entire contents of which are incorporated by reference herein.

### BACKGROUND

The present disclosure relates to a technique to manage installation locations of image forming apparatuses.

A system is known in which a plurality of image forming apparatuses (e.g., multifunction peripherals) are connected via a network. When the installation location of the image forming apparatus is properly managed in such a system, the user can easily cause a closest one of the image forming apparatuses to output a printed matter, from his/her own personal computer. Accordingly, some techniques to manage the location of devices have been developed.

### SUMMARY

The disclosure proposes further improvement of the foregoing technique.

In an aspect, the disclosure provides a management system includes a plurality of image forming apparatuses and a management apparatus. The management apparatus includes a storage device, a first operation device, a first communication device, and a first control device. In the storage device, location information of each of the plurality of image forming apparatuses is stored. The first operation device is for receiving an instruction of a user. The first communication device makes data communication with the plurality of image forming apparatuses. The first control device includes a processor, and acts as a first controller when the processor operates according to a first control program. The first controller requests, when the first operation device receives a first instruction for designating one of the plurality of image forming apparatuses, the designated image forming apparatus to transmit the location information, through the first communication device, and updates, upon receipt of the location information transmitted from the designated image forming apparatus in response to the request, through the first communication device, the location information stored in the storage device, using the received location information. The image forming apparatus includes a first display device, a second operation device, a second communication device, an alert device, and a second control device. The second operation device is for receiving an instruction of a user. The second communication device makes data communication with the management apparatus. The alert device outputs a notice to outside the image forming apparatus. The second control device includes a processor, and acts as a second controller when the processor operates according to a second control program. The second controller causes the first display device to display a screen urging the user to input an installation location of the image forming apparatus, and causes the alert device to output the notice, when the second communication device receives the request transmitted from the management apparatus, and transmits, when the second operation device receives the input of the installation location, the location information indicating the installation location that has been received, to the management apparatus through the second communication device.

In another aspect, the disclosure provides a management apparatus including a storage device, a first operation device, a first communication device, and a first control device. In the storage device, location information of each of a plurality of image forming apparatuses is stored. The first operation device is for receiving an instruction of a user. The first communication device makes data communication with the plurality of image forming apparatuses. The first control device includes a processor, and acts as a first controller when the processor operates according to a first control program. The first controller requests, when the first operation device receives a first instruction for designating one of the plurality of image forming apparatuses, the designated image forming apparatus to transmit the location information, through the first communication device, and updates, upon receipt of the location information transmitted from the designated image forming apparatus in response to the request, through the first communication device, the location information stored in the storage device, using the received location information.

In still another aspect, the disclosure provides an image forming apparatus including a first display device, a second operation device, a second communication device, an alert device, and a second control device. The second operation device is for receiving an instruction of a user. The second communication device makes data communication with a management apparatus. The alert device outputs a notice to outside the image forming apparatus. The second control device includes a processor, and acts as a second controller when the processor operates according to a second control program. The second controller causes the first display device to display a screen urging the user to input an installation location of the image forming apparatus, and causes the alert device to output the notice, when the second communication device receives a request to transmit the location information of the image forming apparatus, transmitted from the management apparatus, and transmits, when the second operation device receives the input of the installation location, the location information indicating the installation location that has been received, to the management apparatus through the second communication device.

### BRIEF DESCRIPTION OF THE DRAWINGS

FIG. 1 is a schematic diagram showing a general configuration of a management system according to a first embodiment of the disclosure;

FIG. 2 is a functional block diagram showing an essential internal configuration of a management apparatus;

FIG. 3 is a table showing an example of apparatus information;

FIG. 4A to FIG. 4C are schematic diagrams each showing an example of a floor map;

FIG. 5 is a table showing an example of location information;

FIG. 6 is a schematic drawing showing an example of a second operation screen;

FIG. 7 is a schematic drawing showing an example of a third operation screen;

FIG. 8A is an enlarged view of a lower left section of the third operation screen;

FIG. 8B is an enlarged view of an upper right section of the third operation screen;

FIG. 9 is a schematic drawing showing an example of a first operation screen;

FIG. 10 is a functional block diagram showing an essential internal configuration of an image forming apparatus;

FIG. 11 is a flowchart showing an example of an updating process of the location information;

FIG. 12 is a schematic drawing showing an example of a pop-up screen; and

FIG. 13 is a schematic diagram showing a general configuration of a management system according to a second embodiment of the disclosure.

### DETAILED DESCRIPTION

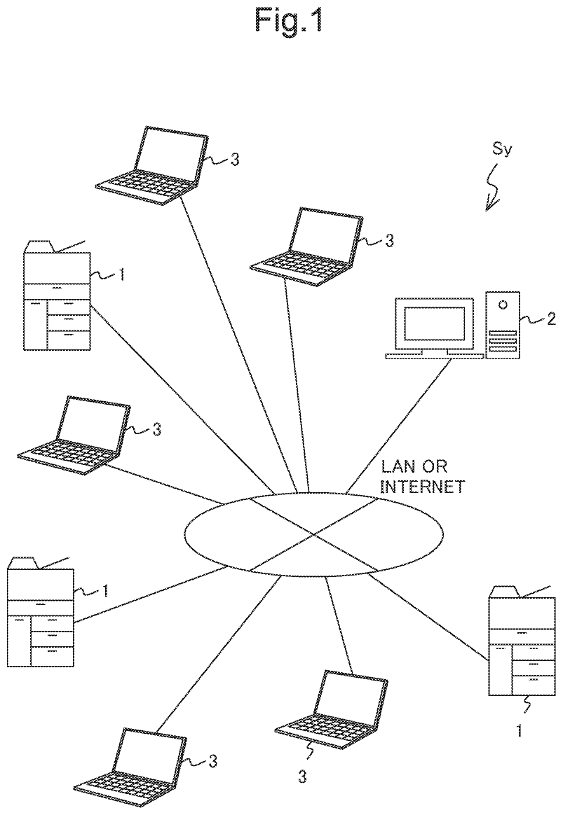

Hereafter, a management system, a management apparatus, and an image forming apparatus according to some embodiments of the disclosure will be described, with reference to the drawings. FIG. 1 is a schematic diagram showing a general configuration of the management system according to a first embodiment of the disclosure.

The management system Sy includes a plurality of image forming apparatuses 1 and the management apparatus 2, located on a network such as the internet. The image forming apparatus 1 is a multifunction peripheral having a plurality of functions such as a copying function, a printing function, a scanning function, and a facsimile function. The management apparatus 2 is, for example, a personal computer (PC) server. The management apparatus 2 manages the plurality of image forming apparatuses 1. The terminal device 3 is, for example, a PC. The terminal devices 3 can instruct a desired image forming apparatus 1 to execute a printing operation.

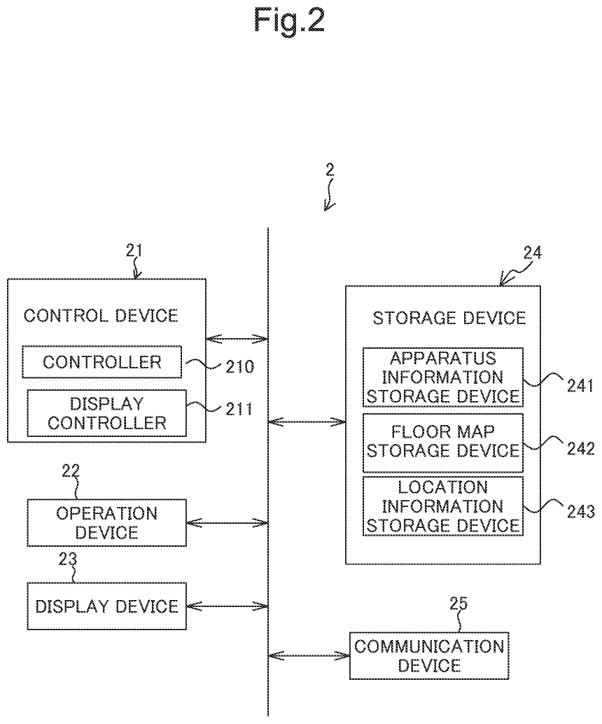

FIG. 2 is a functional block diagram showing an essential internal configuration of the management apparatus 2. The management apparatus 2 includes a control device 21, an operation device 22, a display device 23, a storage device 24, and a communication device 25. The mentioned devices can transmit and receive data or signals to and from one another, through a communication path.

The operation device 22 includes a keyboard and a mouse. The user can input a command or a character through the keyboard, and move the pointer on the screen of the display device 23, using the mouse. The operation device 22 receives instructions inputted by the user.

The display device 23 is, for example, constituted of a liquid crystal display (LCD). The display device 23 displays a response or data, outputted from the control device 21.

The storage device 24 is, for example, a hard disk drive (HDD) or a solid-state drive (SSD). The storage device 24 contains various control programs. The storage device 24 includes, as storage regions, an apparatus information storage device 241, a floor map storage device 242, and a location information storage device 243.

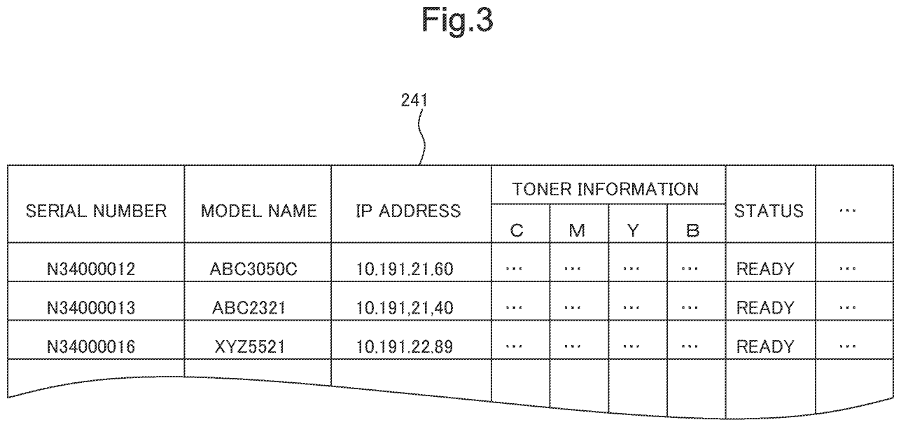

In the apparatus information storage device 241, apparatus information about each of the plurality of image forming apparatuses 1, which are the objects of the management, is stored, in association with an identification number. FIG. 3 illustrates an example of the apparatus information.

The apparatus information storage device 241 contains the apparatus information such as model name, IP address, toner information, and apparatus status, in association with the identification number (Serial number). The toner information indicates the article name or remaining amount of each of a cyan toner, a magenta toner, a yellow toner, and a black toner. For example, as shown in FIG. 3, the apparatus information such as the model name “ABC3050c”, the IP address “10.191.21.60”, and the apparatus status of “Ready” is stored in the apparatus information storage device 241, in association with the identification number “N34000012”.

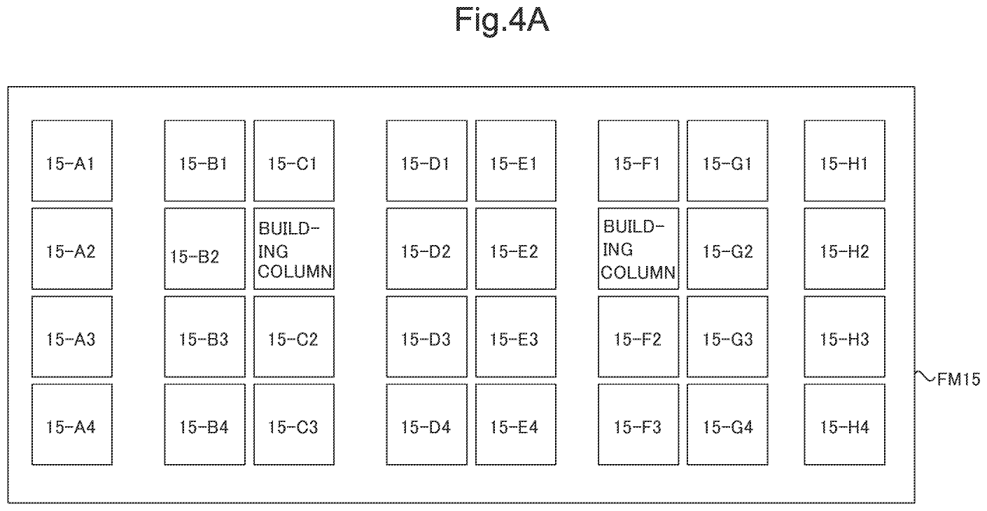

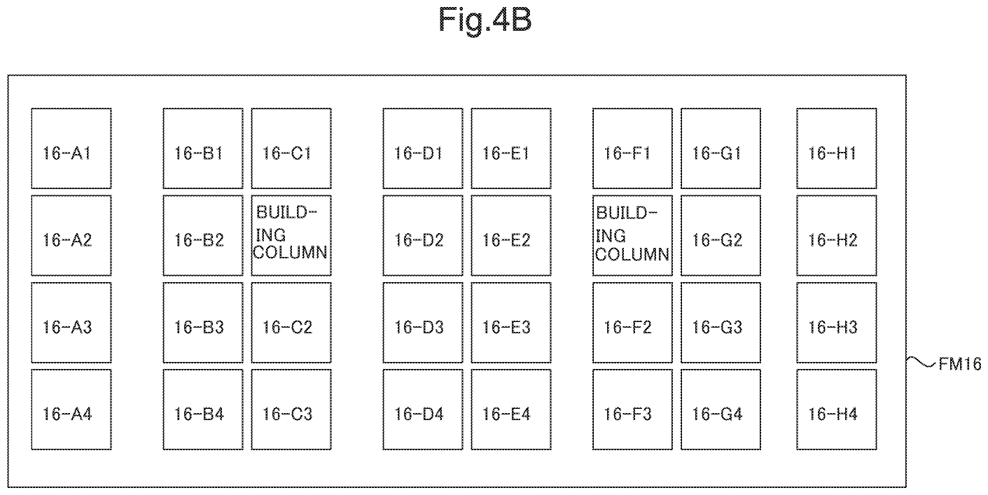

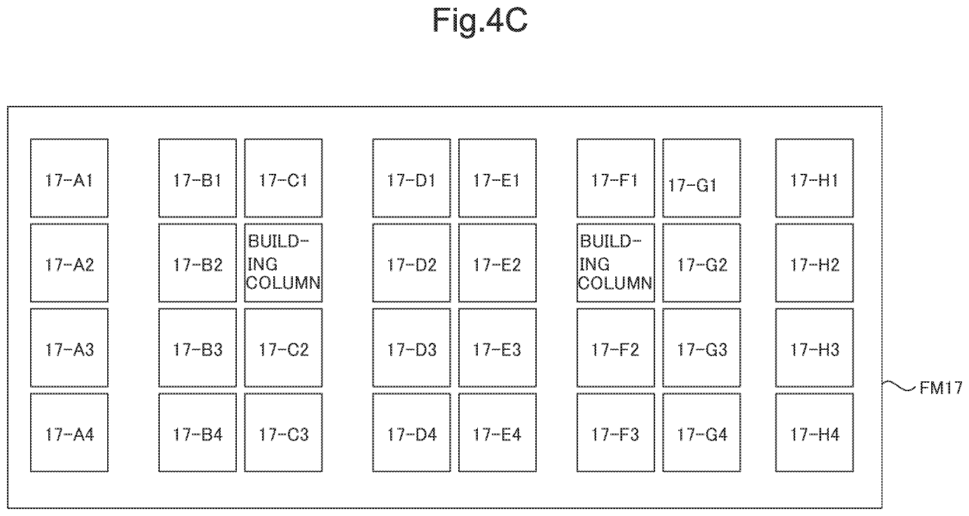

In the floor map storage device 242, floor maps of the building in which the image forming apparatuses 1 are installed, are stored. For example, when the office in which the image forming apparatuses 1 are installed occupies three floors in the building, the floor maps FM15 to FM17, each indicating a plurality of sections (locations) arranged on the floor as shown in FIGS. 4A to 4C, are stored in the floor map storage device 242.

The floor map FM15 shows the floor map of the 15th floor of the building. The floor map FM16 shows the floor map of the 16th floor of the building. The floor map FM17 shows the floor map of the 17th floor of the building. The floor map FM15 shows 30 sections numbered as “15-A1” to “15-H4”, and two building columns. The section numbers “15-A1” to “15-H4” each correspond to a possible installation location for the image forming apparatus 1.

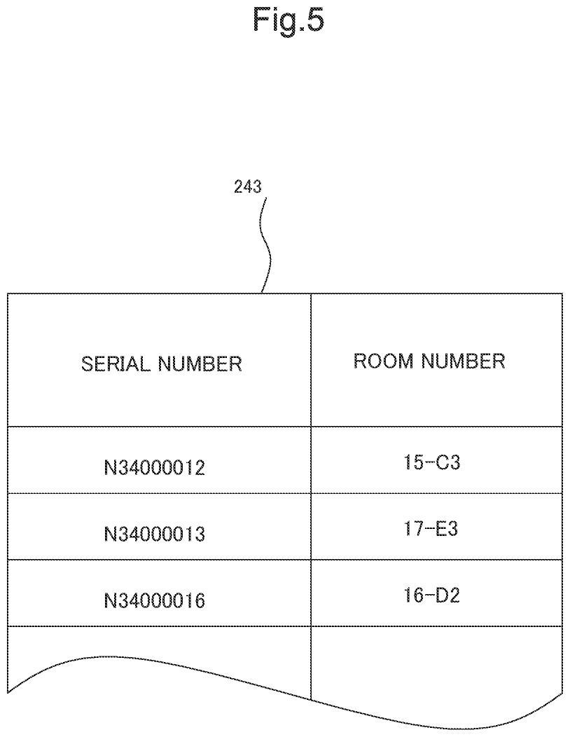

In the location information storage device 243, the location information of each of the plurality of image forming apparatuses 1 to be managed is stored. FIG. 5 illustrates an example of the location information.

In the location information storage device 243, the section number (room number) of each of the plurality of image forming apparatuses 1 is stored, in association with the identification number (serial number). For example, the section number “15-C3” is stored in association with the identification number “N34000012”, in the location information storage device 243.

The communication device 25 is a communication interface for transmitting and receiving data to and from external devices located inside a local area or on the internet. For example, the communication device 25 makes data communication with the plurality of image forming apparatuses 1 and the plurality of terminal devices 3.

The control device 21 includes a processor, a random-access memory (RAM), a read-only memory (ROM), and an exclusive hardware circuit. The processor is, for example, a central processing device (CPU), an application specific integrated circuit (ASIC), or a micro processing device (MPU).

The control device 21 acts as a controller 210 and a display controller 211, when the processor operates according to a first control program stored in the storage device 24. The controller 210 controls the overall operation of the management apparatus 2. To be more detailed, the controller 210 is connected to the operation device 22, the display device 23, the storage device 24, and the communication device 25. The controller 210 controls the operation of the mentioned devices, and transmits and receives signals and data to and from the mentioned devices. For example, the controller 210 stores the apparatus information transmitted from the image forming apparatus 1 in the apparatus information storage device 241, in association with the identification number of the image forming apparatus 1.

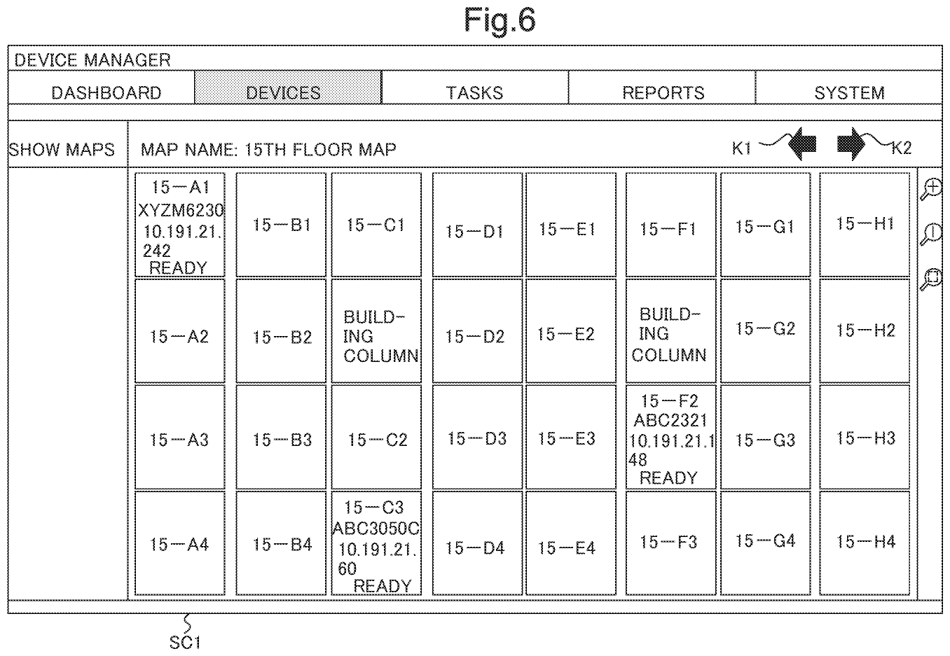

The display controller 211 controls the displaying operation of the display device 23. For example, upon receipt of an instruction for requesting display of the map showing the installation location of the plurality of image forming apparatuses 1, through the operation device 22, the display controller 211 generates a floor map in which the apparatus information of each of the plurality of image forming apparatuses 1 is indicated in the installation location of the corresponding image forming apparatus 1, using the location information stored in the location information storage device 243 and the apparatus information stored in the apparatus information storage device 241, and causes the display device 23 to display a second operation screen SC1, showing the floor map generated as above, as shown in FIG. 6.

In this example, the display controller 211 causes the display device 23 to display “15th floor map” in the second operation screen SC1, and the apparatus information (model name, IP address, and apparatus status) in the sections numbered as “15-A1”, “15-C3”, and “15-F2”.

For example, when the installation location of the image forming apparatus 1 having the identification number “N34000012” is the section numbered as “15-C3” as shown in FIG. 5, and the image forming apparatus 1 having the identification number “N34000012” has the model name “ABC3050c” and the IP address “10.191.21.60”, and is in the apparatus status “Ready”, as shown in FIG. 3, the display controller 211 causes the display device 23 to display “ABC3050c”, “10.191.21.60”, and “Ready” in the section numbered as “15-C3”, as shown in FIG. 6.

The display controller 211 also causes the display device 23 to display an operation key K1 representing a left-pointing arrow, and an operation key K2 representing a right-pointing arrow, in the second operation screen SC1. When the operation device 22 receives a switching instruction of the floor map according to a user's operation performed on the operation key K1 of the operation key K2, the display controller 211 switches the floor map to be displayed on the second operation screen SC1.

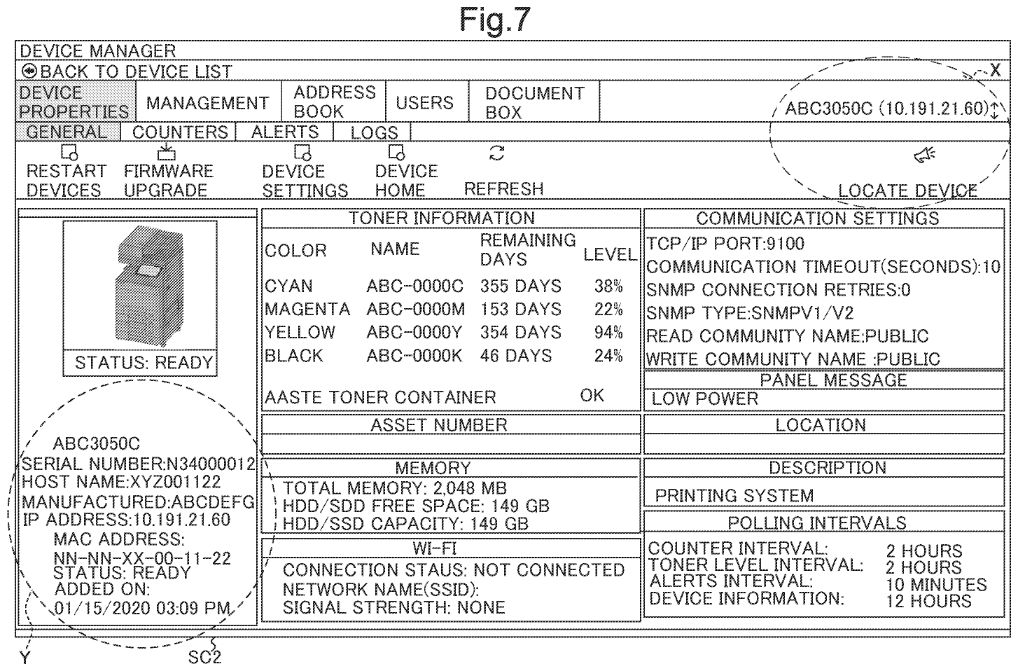

In addition, when the operation device 22 receives an instruction to display the apparatus information (device properties) of the image forming apparatus 1, the display controller 211 causes the display device 23 to display a third operation screen SC2, indicating the apparatus information of the image forming apparatus 1 to be managed, as shown in FIG. 7.

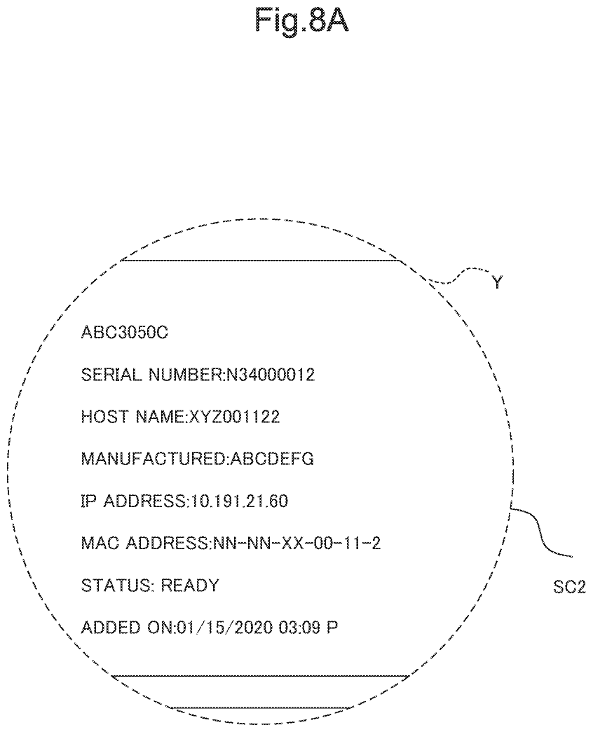

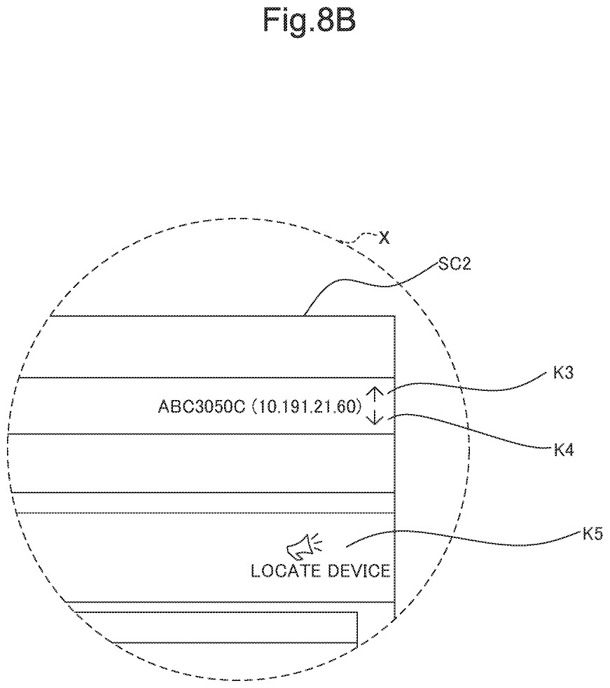

FIG. 8A is an enlarged view of a lower left section of the third operation screen SC2 (section Y surrounded by a dotted circle). As shown therein, the display controller 211 causes the display device 23 to display the model name “ABC3050c”, “identification number (serial number): N34000012”, “IP address (IP address): 10.191.21.60”, and “apparatus status: Ready”, in the lower left section of the third operation screen SC2.

FIG. 8B is an enlarged view of an upper right section of the third operation screen SC2 (section X surrounded by a dotted circle). The display controller 211 causes the display device 23 to display the model name “ABC3050c” and the IP address “10.191.21.60” in the upper right section of the third operation screen SC2, with an operation key K3 representing an upward arrow and an operation key K4 representing a downward arrow displayed on the right of the first mentioned display. The display controller 211 also causes the display device 23 to display an operation key K5 representing a sign of a loudspeaker on the lower side of the operation key K4, with a character string “locate device” displayed under the operation key K5.

When the operation device 22 receives the switching instruction of the apparatus information according to the user's operation on the operation key K3 or operation key K4, the display controller 211 switches the apparatus information to be displayed on the third operation screen SC2, according to the order of the identification number.

For example, when the operation device 22 receives the switching instruction of the apparatus information according to the user's operation on the operation key K4, while the third operation screen SC2 shown in FIG. 7 is displayed on the display device 23 (i.e., while the apparatus information related to the identification number “N34000012” is displayed), the display controller 211 switches the display of the apparatus information, by retrieving the apparatus information related to the identification number “N34000013” from the apparatus information storage device 241, and displaying the retrieved information.

When the operation device 22 receives an instruction to transmit the location information, according to the user's operation on the operation key K5, the controller 210 requests, through the communication device 25, the image forming apparatus 1 corresponding to the apparatus information displayed on the display device 23 at the time that the user's instruction has been received, to transmit the location information.

For example, when the operation device 22 receives the instruction to transmit the location information according to the user's operation on the operation key K5, while the third operation screen SC2 shown in FIG. 7 is displayed on the display device 23 (i.e., while the apparatus information related to the identification number “N34000012” is displayed), the controller 210 requests, through the communication device 25, the image forming apparatus 1 having the identification number “N34000012” (IP address “10.191.21.60”), to transmit the location information. In other words, when the operation device 22 receives the instruction for designating one of the plurality of image forming apparatuses 1 being managed (in this case, the transmission instruction), the controller 210 requests the designated image forming apparatus 1 to transmit the location information, through the communication device 25.

In addition, when making the mentioned request, the controller 210 transmits, to the image forming apparatus 1 through the communication device 25, an image representing a first operation screen for urging the user to select one of the plurality of possible installation locations registered in advance (in this case, the plurality of section numbers shown in FIG. 4).

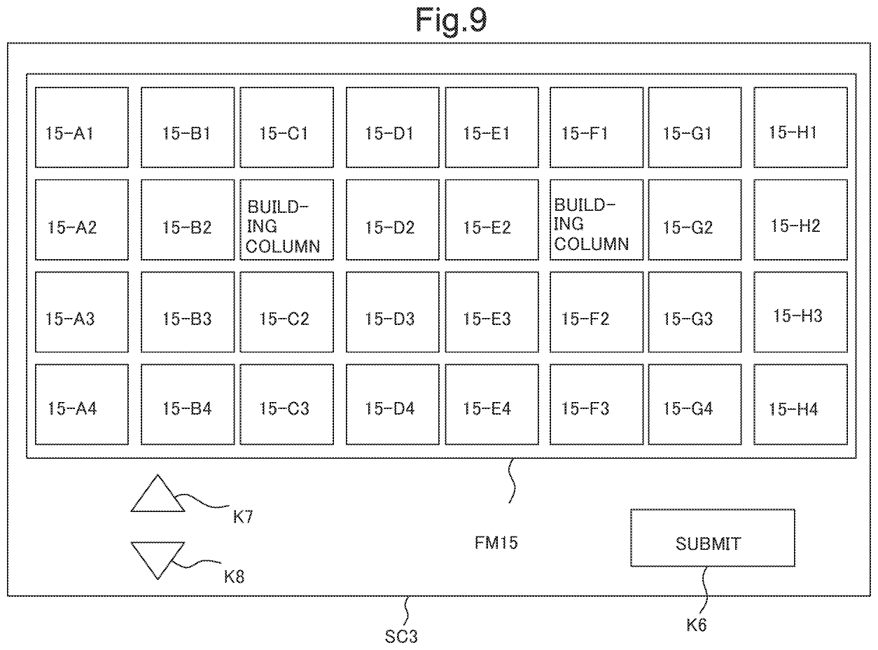

FIG. 9 illustrates an example of the first operation screen. The first operation screen SC3 includes, for example, the floor map FM15 showing the plurality of section numbers, an operation key K6 indicating a character string “submit”, an operation key K7 representing a sign of an upward triangle, and an operation key K8 representing a sign of a downward triangle. A plurality of rectangular regions representing the respective section numbers each serve as a selection key.

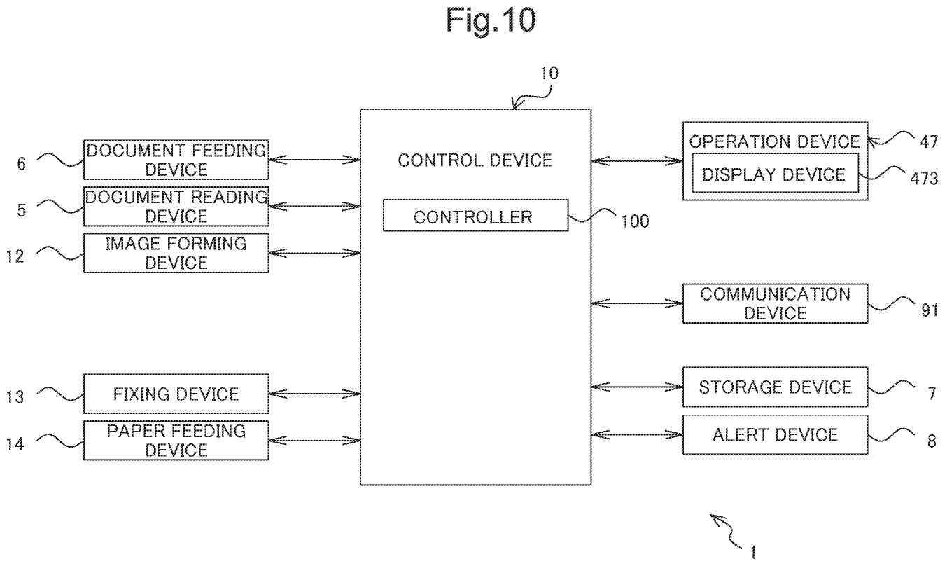

Referring to FIG. 10, when a communication device 91 receives the aforementioned image transmitted from the management apparatus 2, a controller 100 of the image forming apparatus 1 causes a display device 473 to display the first operation screen SC3. The first operation screen SC3 has a tier structure, which is switchable. In this case, the controller 100 causes the display device 473 to display the floor map FM15 of the 15th floor in the first tier, the floor map FM16 of the 16th floor in the second tier, and the floor map FM17 of the 17th floor in the third tier. The tier can be switched by the controller 100, when an operation device 47 receives the instruction to switch the tier, according to the user's operation on the operation key K7 or operation key K8. The operation key K6 will be subsequently described.

Upon receipt, through the communication device 25 (exemplifying the first communication device), of the location information transmitted from the designated image forming apparatus 1 in response to the request, the controller 210 updates the location information stored in the location information storage device 243, using the location information that has been received.

FIG. 10 is a functional block diagram showing an essential internal configuration of the image forming apparatus 1. The image forming apparatus 1 includes a control device 10, a document feeding device 6, a document reading device 5, an image forming device 12, a fixing device 13, a paper feeding device 14, the operation device 47, the communication device 91, a storage device 7, and an alert device 8.

The document feeding device 6 is openably mounted on the upper face of the document reading device 5, via a hinge. The document feeding device 6 serves as a document retention cover, when the source document placed on a platen glass is to be read. The document feeding device 6 is an automatic document feeder (ADF) including a document tray. The document feeding device 6 feeds the source document placed on the document tray, to the document reading device 5.

To perform the document reading operation, the image forming apparatus 1 operates as follows. The document reading device 5 optically reads the image on a source document delivered from the document feeding device 6 to the document reading device 5, or placed on a platen glass, and generates image data. The image data generated by the document reading device 5 is stored, for example, in an image memory.

To perform the image forming operation, the image forming apparatus 1 operates as follows. The image forming device 12 forms a toner image on a recording sheet delivered from the paper feeding device 14, on the basis of the image data generated through the document reading operation, image data stored in the image memory, or image data received from a computer connected via a network.

The fixing device 13 heats and presses the recording sheet on which the toner image has been formed by the image forming device 12, to thereby fix the toner image on the recording sheet. The recording sheet that has undergone the fixing process is delivered to an output tray. The paper feeding device 14 includes one or more paper cassettes.

The operation device 47 receives instructions from the user to execute the functions and operations that the image forming apparatus 1 is configured to perform, for example the image forming operation. The operation device 47 includes a display device 473 for displaying, for example, an operation guide for the user. The display device 473 includes a touch panel, so that the operation device 47 can receive the user's instruction inputted by user's operation (for example, touch operation) on the operation screen displayed on the display device 473.

The display device 473 includes, for example, an LCD. The display device 473 also includes a touch panel. When the user touches a button or a key displayed on the display device 473, the touch panel receives the instruction corresponding to the touched position.

The communication device 91 is a communication interface for transmitting and receiving data to and from external devices located inside a local area or on the internet. For example, the communication device 91 makes data communication with the management apparatus 2 and the plurality of terminal devices 3. The storage device 7 is, for example, an HDD or an SSD. The storage device 7 contains various control programs.

The alert device 8 outputs a notice to attract the attention of the user, to outside the image forming apparatus 1. The alert device 8 may be, for example, an audio output device that outputs voices and sounds.

The control device 10 includes a processor, a RAM, a ROM, and an exclusive hardware circuit. The processor is, for example, a CPU, an ASIC, or an MPU.

The control device 10 acts as the controller 100, when the processor operates according to a second control program stored in the storage device 7. Here, the controller 100 may be constituted in the form of a hardware circuit, instead of being realized by the control device 10 according to the control program. This also applies to other embodiments, unless otherwise specifically noted.

The controller 100 controls the overall operation of the image forming apparatus 1. The controller 100 is connected to the document feeding device 6, the document reading device 5, the image forming device 12, the fixing device 13, the paper feeding device 14, the operation device 47, the communication device 91, the storage device 7, and the alert device 8, to control the operation of the mentioned components.

For example, when the communication device 91 receives the request transmitted from the management apparatus 2, the controller 100 causes the display device 473 to display a screen for urging the user to input the installation location of the image forming apparatus 1, and causes the alert device 8 to output the notice. When the operation device 47 receives the input of the installation location made by the user, the controller 100 transmits the location information indicating the installation location that has been inputted, to the management apparatus 2 through the communication device 91.

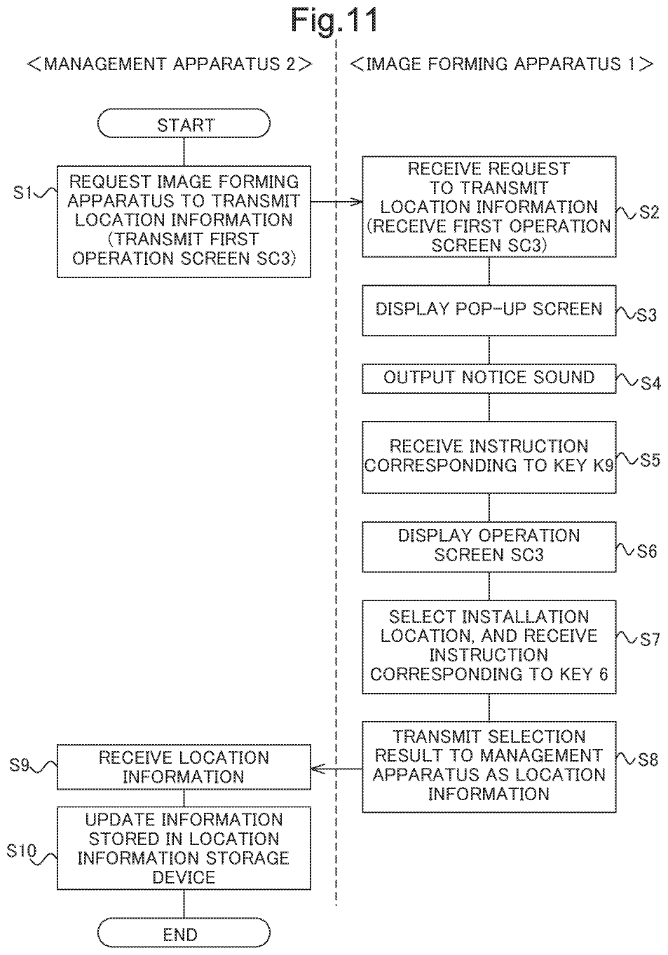

Referring now to the flowchart shown in FIG. 11, an example of a location information updating process, performed by the control device 21 of the management apparatus 2 and the control device 10 of the image forming apparatus 1, will be described hereunder.

When the operation device 22 receives the instruction to transmit the location information, according to the user's operation on the operation key K5 in the third operation screen SC2 shown in FIG. 8B, the controller 210 of the management apparatus 2 starts the location information updating process shown in FIG. 11, and requests, through the communication device 25, the image forming apparatus 1 corresponding to the apparatus information displayed on the display device 23 at the time that the user's operation has been received, to transmit the location information (step S1). When doing so, the controller 210 transmits the image representing the first operation screen SC3 shown in FIG. 9 to the image forming apparatus 1, through the communication device 25. However, the controller 210 may transmit the first operation screen SC3 beforehand, to the image forming apparatus 1.

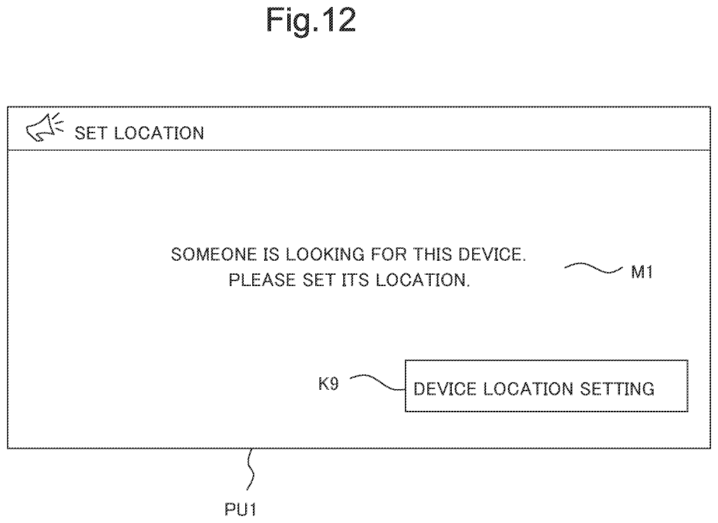

When the communication device 91 receives the mentioned request transmitted from the management apparatus 2 (step S2), the controller 100 of the image forming apparatus 1 causes the display device 473 to display a pop-up screen PU1 titled as “Set Location” as shown in FIG. 12, as a screen for urging the user to input the installation location of the image forming apparatus 1 (step S3). The controller 100 also causes the alert device 8 to output the notice sound to outside the image forming apparatus 1 (step S4).

The controller 100 causes the display device 473 to include a message M1 as “Someone is looking for this device. Please set its location.”, and an operation key K9 representing a character string “Device location setting”, in the pop-up screen PU1. Thus, the controller 100 causes the display device 473 to display the pop-up screen PU1, including the message for urging the user present around the image forming apparatus 1, to input the installation location of the image forming apparatus 1.

It is for the purpose of making the user recognize the pop-up screen PU1 displayed on the display device 473, by attracting the attention of the user present around the image forming apparatus 1, thereby urging the user to cooperate in inputting the installation location of the image forming apparatus 1, that the controller 100 causes the alert device 8 to output the notice sound.

When the operation device 47 receives the instruction to display the first operation screen SC3, according to the user's operation on the operation key K9 in the pop-up screen PU1 (step S5), the controller 100 causes the display device 473 to display the first operation screen SC3 shown in FIG. 9, transmitted from the management apparatus 2 and received by the communication device 91 (step S6).

Thereafter, when the operation device 47 receives the user's operation performed on one of the plurality of selection keys in the first operation screen SC3, respectively representing the plurality of section numbers, and on the operation key K6 (step S7), the controller 100 transmits the location information indicating the section number corresponding to the selected key, to the management apparatus 2 through the communication device 91 (step S8).

In other words, when the operation device 47 receives the instruction to select one of the plurality of possible installation locations (in this case, the plurality of section numbers shown in FIG. 9), the controller 100 transmits the location information indicating the selected one of the possible installation locations as the installation location, to the management apparatus 2 through the communication device 91. For example, when the user touches the selection key indicating the section number “15-B2”, and then touches the operation key K6, the controller 100 transmits the location information indicating the section number “15-B2”, to the management apparatus 2.

Upon receipt of the location information transmitted from the image forming apparatus 1 through the communication device 25 (step S9), the controller 210 of the management apparatus 2 updates the location information stored in the location information storage device 243, using the location information that has been received (step S10). After step S10, the controller 210 finishes the location information updating process. Through the mentioned process, the location information stored in the location information storage device 243 is updated to the correct information, provided that the user present around the image forming apparatus 1 correctly inputs the installation location of the image forming apparatus 1.

Here, known techniques to identify the location of the image forming apparatus include utilizing the global positioning system (GPS). However, when the image forming apparatus is located in a circumstance where the GPS is unavailable, the method of utilizing the GPS is unable to be employed to accurately identify the location of the image forming apparatus.

With the arrangement according to the first embodiment, in contrast, the management apparatus 2 updates the location information stored in the location information storage device 243, using the location information inputted by the user. In other words, the installation location of the image forming apparatus 1 can be identified on the basis of the location information, inputted through the cooperation of the user present around the image forming apparatus 1, instead of depending on the GPS like the known technique, so that the location information of the image forming apparatus 1 being managed can be updated. Therefore, the installation location of each of the plurality of image forming apparatuses 1, the objects of the management, can be more properly managed.

Further, the image forming apparatus 1 not only displays the pop-up screen PU1 for urging the user to input the installation location, but also outputs the notice sound to outside the image forming apparatus, to attract the attention of the user, when the request to transmit the location information is received. Such an arrangement further assures that the user cooperates in inputting the location information.

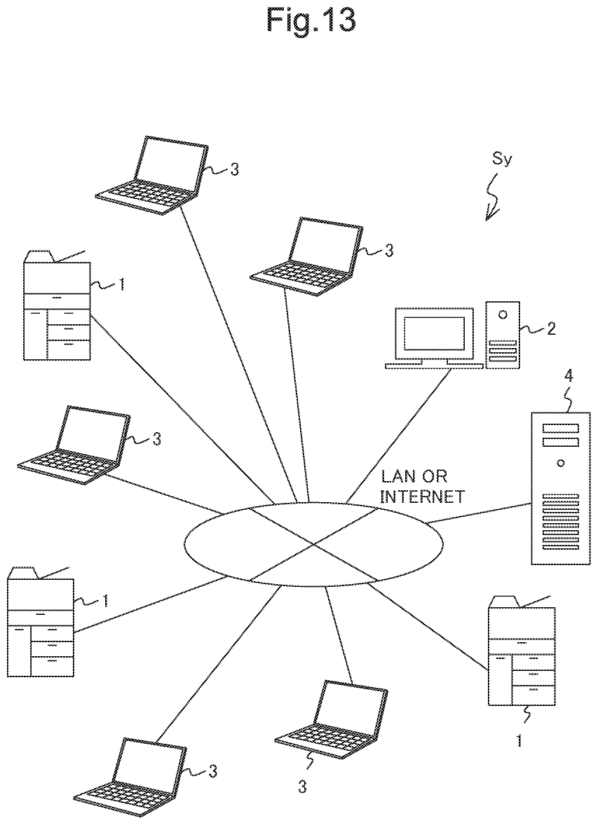

Although the storage device 24 of the management apparatus 2 according to the first embodiment includes the apparatus information storage device 241, the floor map storage device 242, and the location information storage device 243, the disclosure is not limited to such a configuration. FIG. 13 is a schematic diagram showing a general configuration of a management system according to a second embodiment of the disclosure. As shown in FIG. 13, the management system Sy according to the second embodiment further includes a server 4. In the second embodiment, the server 4 includes the apparatus information storage device 241, the floor map storage device 242, and the location information storage device 243. The management apparatus 2 can make access to the server 4 whenever necessary, to retrieve required information from the storage devices 241, 242, and 243, and update the information. In this case, the management apparatus 2 and the server 4 correspond to the “management apparatus” in the disclosure.

The disclosure may be modified in various manners, without limitation to the foregoing embodiments. For example, although the embodiments take up the MFP as an example of the image forming apparatus according to the disclosure, the disclosure is also applicable to various other image forming apparatuses having a copying function, a printing function, or a facsimile function.

The configurations and processings described with reference to FIG. 1 to FIG. 13 are merely exemplary, and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. A management system comprising:
a plurality of image forming apparatuses; and
a management apparatus,
wherein the management apparatus includes:
a storage device in which location information of each of the plurality of image forming apparatuses is stored;
a first operation device for receiving an instruction of a user;
a first communication device that makes data communication with the plurality of image forming apparatuses; and
a first control device including a processor, and configured to act, when the processor operates according to a first control program, as a first controller that:
requests, when the first operation device receives a first instruction for designating one of the plurality of image forming apparatuses, the designated image forming apparatus to transmit the location information, through the first communication device; and
updates, upon receipt of the location information transmitted from the designated image forming apparatus in response to the request, through the first communication device, the location information stored in the storage device, using the received location information, and
the image forming apparatus includes:
a first display device;
a second operation device for receiving an instruction of a user;
a second communication device that makes data communication with the management apparatus;
an alert device that outputs a notice to outside the image forming apparatus; and
a second control device including a processor, and configured to act, when the processor operates according to a second control program, as a second controller that:
causes the first display device to display a screen urging the user to input an installation location of the image forming apparatus, and causes the alert device to output the notice, when the second communication device receives the request transmitted from the management apparatus; and
transmits, when the second operation device receives the input of the installation location, the location information indicating the installation location that has been received, to the management apparatus through the second communication device.

2. The management system according to claim 1,
wherein the alert device of the image forming apparatus includes an audio output device, and
the second controller causes the alert device to output the notice, by causing the audio output device to output a notice sound.

3. The management system according to claim 1,
wherein the storage device of the management apparatus further contains a plurality of possible installation locations of the image forming apparatus,
the first controller of the management apparatus transmits an image representing a first operation screen for urging selection of one of the plurality of possible installation locations, to the image forming apparatus through the first communication device, and
when the second communication device receives the image transmitted from the management apparatus, the second controller of the image forming apparatus causes the first display device to display the first operation screen, and transmits, when the second operation device receives a second instruction for selecting the one of the possible installation locations, the location information indicating the selected possible installation location as the installation location, to the management apparatus through the second communication device.

4. The management system according to claim 1,
wherein the management apparatus further includes a second display device,
the storage device of the management apparatus further contains apparatus information of each of the plurality of image forming apparatuses, and
the first control device of the management apparatus further acts as a display controller that generates, upon receipt of a third instruction for requesting display of a map showing installation location of the plurality of image forming apparatuses, through the first operation device, the map on which the apparatus information related to each of the plurality of image forming apparatuses is indicated in the installation location of the corresponding image forming apparatus, using the location information and the apparatus information, and causes the second display device to display a second operation screen representing the generated map.

5. A management apparatus comprising:
a storage device in which location information of each of a plurality of image forming apparatuses is stored;
a first operation device for receiving an instruction of a user;
a first communication device that makes data communication with the plurality of image forming apparatuses; and
a first control device including a processor, and configured to act, when the processor operates according to a first control program, as a first controller that:
requests, when the first operation device receives a first instruction for designating one of the plurality of image forming apparatuses, the designated image forming apparatus to transmit the location information, through the first communication device; and
updates, upon receipt of the location information transmitted from the designated image forming apparatus in response to the request, through the first communication device, the location information stored in the storage device, using the received location information.

6. An image forming apparatus comprising:
a first display device;
a second operation device for receiving an instruction of a user;
a second communication device that makes data communication with a management apparatus;
an alert device that outputs a notice to outside the image forming apparatus; and
a second control device including a processor, and configured to act, when the processor operates according to a second control program, as a second controller that:
causes the first display device to display a screen urging the user to input an installation location of the image forming apparatus, and causes the alert device to output the notice, when the second communication device receives a request to transmit the location information of the image forming apparatus, transmitted from the management apparatus; and
transmits, when the second operation device receives the input of the installation location, the location information indicating the installation location that has been received, to the management apparatus through the second communication device.
